(19) United States
(12) Patent Application Publication
(10) Pub. No.: US 2014/0344471 A1
(43) Pub. Date: Nov. 20, 2014

(54) Progressive Download Prioritisation

(71) Applicants: Andras Valkó, Hasselby (SE); Zoltán Richárd Turányi, Szentendre (HU)

(72) Inventors: Andras Valkó, Hasselby (SE); Zoltán Richárd Turányi, Szentendre (HU)

(73) Assignee: TELEFONAKTIEBOLAGET L M ERICSSON (PUBL), Stockholm (SE)

(21) Appl. No.: 14/362,630

(22) PCT Filed: Dec. 8, 2011
(86) PCT No.: PCT/EP2011/072222

§ 371 Date: Jun. 4, 2014

(51) Int. Cl. H04L 29/06; H04L 29/08; H04L 12/26

(52) U.S. Cl. CPC H04L 65/4069; H04L 43/0852; H04L 67/322
USPC 709/231

(57) ABSTRACT

Apparatus for handling packets within a Progressive Download stream for delivery from a media server to a client terminal over an access network. The apparatus comprises a session analysis module for determining, for each packet of the Progressive Download stream, one or both of e) a playout latency factor indicative of the time duration until the media within the packet is required to be played out at the client terminal, and f) a quality factor indicative of the importance of the media within the packet to the quality of the media to be played out at the client terminal. The apparatus further comprises a prioritisation module for determining an access network delivery priority for the packet, or to be applied to the Progressive Download stream, using the playout latency factor and/or the quality factor.

### TECHNICAL FIELD

The present disclosure relates to the prioritisation of data delivery within a progressive (media) download.

### BACKGROUND

Over-the-top (OTT) delivery can be defined as the delivery of content, e.g. voice and or video, over an access network without the access network provider being involved in the control or distribution of the content itself. Today, OTT services are delivered as normal best effort (BE) traffic. However, in some cases the OTT applications require specific treatment in order to obtain a satisfactory experience at the receiver side, often referred as Quality of Experience (QoE). This is particularly true in the case of cellular access networks.

One important application example of OTT is referred to as progressive media download or more simply Progressive Download (PD). PD is a way to download pre-recorded media content from a server to a client. Using PD, a client application can start playback of the media before the entire content is downloaded. When the download starts, the client application stores the beginning of the media file in a playout buffer. This phase is called “initial buffering”. When the buffer contains a certain amount of media content (e.g., the first few seconds), the client application starts playback, while at the same time it continues to download content into the playout buffer. If the download speed is sufficient, download will always be “ahead of” playback, hence the user will receive a continuous media experience. If, on the other hand, the download speed is insufficient, or there are temporary connectivity problems, then the media playback can “catch up” with download, reaching a point in the media file that is missing from the buffer. At this point, the media playback has to be paused until the download process has progressed to a point where the buffer if filled with at least a few seconds of media content. This process is called rebuffering. Rebuffering is also necessary if a user scrolls ahead in the media file to a point that has not yet been downloaded into the playout buffer. In this case the playout is paused and the client application starts to download the media content from the point to which the user has scrolled.

The provision of a large playout buffer at a client terminal enables a playout process to survive longer network blockages and constrictions, and enhances the video experience. Filling a large playout buffer however represents a potential waste of network resources. For example, if playout is terminated prematurely by a user, data in the playout will likely have been downloaded unnecessarily.

Radio resource management (RRM) is a function in wireless access networks that determines how radio capacity is shared between terminals and user sessions competing for the same shared resource. The scheduling function determines which user equipment (or which user session) should receive priority over the wireless interface at a give time instant, in a given radio channel (e.g., frequency or time slot). RRM mechanisms can be deployed to assist with PDs. For example, a packet scheduler (e.g. implemented in a Radio Network Controller of a 3G network or in an eNB of a LTE/4G network) may differentiate packet streams to facilitate different Quality of Services (QoSs). However, this is a relatively coarse tool and is unable to differently prioritise packets with a given PD.

### SUMMARY

It is an object of the present invention to implement Progressive Download services which result both in an improved end user experience and in the efficient use of bandwidth over the access network.

According to a first aspect of the present invention there is provided a method of handling packets within a Progressive Download stream being delivered from a media server to a client terminal over an access network. The method comprises, for each packet, determining one or both of
a) a playout latency factor indicative of the time duration until the media within the packet is required to be played out at the client terminal, and
b) a quality factor indicative of the importance of the media within the packet to the quality of the media to be played out at the client terminal.

The playout latency factor and/or the quality factor is then used to determine an access network delivery priority for the packet or to be applied to the Progressive Download stream.

The determined access network delivery priority is used within the access network in order to prioritise the delivery of packets within the Progressive Download stream to the client terminal.

The invention is applicable to wireless access networks in which bandwidth may be both restricted and subject to fluctuations. The step of using the determined access network delivery priority in order to prioritise the delivery of packets may be carried out at a Radio Resource Management entity.

A process of Deep Packet Inspection of a packet may be used to determine said playout latency and/or quality factor, with the method further comprising starting a media playout timer at the time of sending a first packet of the Progressive Download to the client terminal and adjusting that timer at the start of any rebuffering event. The result of said Deep Packet Inspection is used to determine a playout time within the Progressive Download for the media within the packet, and the playout latency factor is determined using the difference between said playout time and the current value of the media playout timer.

According to a second aspect of the present invention there is provided apparatus for handling packets within a Progressive Download stream for delivery from a media server to a client terminal over an access network. The apparatus comprises a session analysis module for determining, for each packet of the Progressive Download stream, one or both of
a) a playout latency factor indicative of the time duration until the media within the packet is required to be played out at the client terminal, and
b) a quality factor indicative of the importance of the media within the packet to the quality of the media to be played out at the client terminal.

The apparatus further comprises a prioritisation module for determining an access network delivery priority for the packet, or to be applied to the Progressive Download stream, using the playout latency factor and/or the quality factor.

According to certain embodiments of the invention, the session analysis module performs a Deep Packet Inspection of packets in order to determine said playout latency and quality factors. The prioritisation module may be configured to include said delivery priority within each packet, or may comprise an interface for coupling the prioritisation module to a Radio Resource Management entity, the prioritisation module being configured to send the access network delivery priorities over that interface.

According to a third aspect of the present invention there is provided a media server comprising the apparatus of the above second aspect of the present invention collocated with a Radio Resource Management entity.

### BRIEF DESCRIPTION OF THE DRAWINGS

FIG. 1 illustrates schematically parts of a network architecture for efficiently delivering Progressive Downloads;

FIG. 2 illustrates schematically parts of an alternative network architecture for efficiently delivering Progressive Downloads;

FIG. 3 is a flow diagram illustrating an efficient method of delivering Progressive Download streams.

### DETAILED DESCRIPTION

In the absence of appropriate solutions, it can be expected that the delivery of media such as Internet videos via mobile access will be qualitatively different from that available via a fixed access, resulting in a larger number of media freeze/rebuffering events, especially if the content is served over interactive radio bearers together with other “Best Efforts” traffic. The reason for this is that the bottleneck in the case of mobile access is on the ‘first mile’ (i.e., on the radio interface), and this is vulnerable to both statistically large traffic fluctuations and to channel quality (in turn dependent upon factors such as the subscriber's position, velocity, activity, etc).

One approach to addressing these issues is to apply the standard Quality-of-Service (QoS) architecture for 3GPP (See, e.g., 3GPP TS 23.401 V9.1.0 (2009-06)) to attempt to guarantee the required long-term throughput for all Progressive Download (PD) applications by utilising Guaranteed Bit Rate (GBR) bearers towards the user terminal. This however presents scalability problems in terms of bearer setup signalling and the limited availability of GBR bearers allowed by the mobile network. An alternative, lightweight mechanism is desirable in order to provide better radio spectrum efficiency.

WO2010088490 proposes an approach to efficiently enabling PD applications which makes use of traffic “throttling”. The media content is segmented into smaller parts (e.g., corresponding to two minute video segments) and each segment is scheduled for delivery from the radio access network to the user terminal based on the estimated presentation time (i.e., the time when the given segment is needed by the client). The goal of this approach is that the delivery time for the segment should be less (but not much less) than the presentation time. The load balancing mechanisms employed by the access network over the radio interface ensure that, by delaying some of the segments of a bearer subject to relatively good radio conditions, content sent over other bearers has an increased chance of being delivered in time. The approach described in WO2010088490 achieves traffic throttling by means of an HTTP-proxy or a TCP-proxy, that maintains separate TCP sessions towards the client and the content source, and a transit buffer or cache that temporarily stores the content. The proposed mechanism may also extend to traffic throttling of other types of applications that do not require strict completion deadlines such as is the case with PD video.

The approach of WO2010088490 has a number of potential weaknesses including:
1) Throttling of some high-bandwidth sessions for certain users may indeed provide additional capacity for some other users. However, there is no safe solution for the case when it is detected that data for some application cannot be delivered to a user in time. That is, the approach does not make it possible to give additional resources to this application. It may be difficult to predict the potential gain achievable using the approach and to dimension the network accordingly.
2) Throttling of traffic is generally not spectrum-efficient since it may leave some radio capacity unused even if there is traffic to send. In the case of PD applications for example, such periods could be used to pre-fill the player buffers in anticipation of later congestion.

An approach to optimising progressive download (PD) of media will now be described which addresses at least some of the problems inherent in prior art approaches, including that described in WO2010088490. The approach takes as its starting point an appreciation that, for multiple users downloading media (in this example video) using a shared resource (such as the radio capacity in a cell of a wireless access network), some data packets can be more important or more urgent than others. In particular, packets within a given PD flow associated with initial buffering and rebuffering are likely to be more important from a user experience than “normal” packets. Similarly, where media is encoded with a so-called layered encoding mechanism, packets relating to a base or lower layer (coarse) are likely to be more important than packets relating to a higher layer (enhancement).

In the following description of an optimized PD mechanism, it is assumed that a client (terminal) is connected to a wireless (cellular) access network, and that the transmission capacity bottleneck is the wireless link. Of course, it will be appreciated that the mechanism can be applied in other cases as well, e.g. in the case of a wired access network. The basis of the mechanism is to prioritise those packets within a PD session which are most important from a user experience point of view whilst taking into account any prioritisation arising from operator and subscription related policies. That is, the following three factors may be taken into account:
1) Playout Latency: how close in time is the information carried by a packet to the time that it is required for playback.
2) Quality Value: is the information contained within a packet absolutely necessary for playout (e.g. is it part of a base encoding layer) or is it part of an enhancement layer. In the case of single-layer codecs comprising both I-frames or predictive frames, the former may be prioritised ahead of the latter. For simple, single-layer codecs which do not use prediction, this second factor may be ignored.
3) Session Priority. The operator may assign different priority levels to different users (e.g., gold/silver/bronze subscription), to different content servers (e.g., own video server is prioritized) or to different sessions.

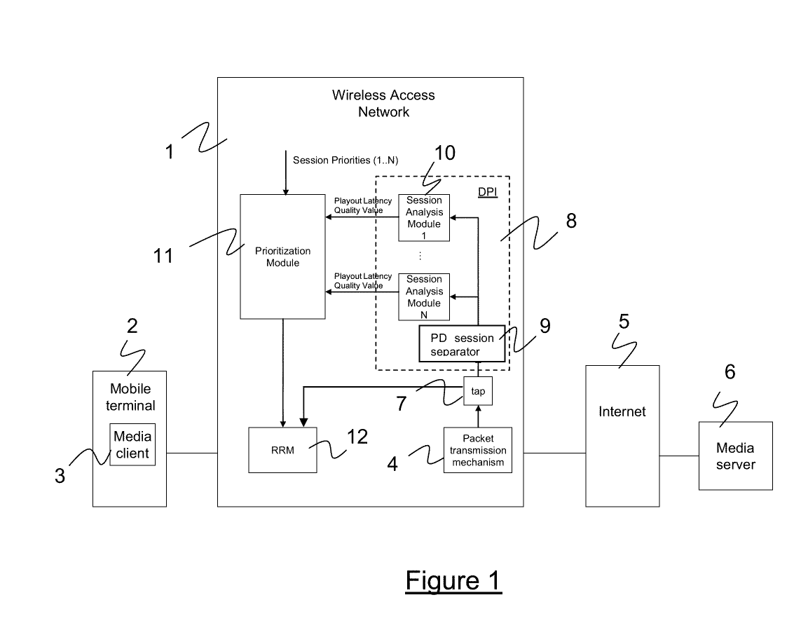

Considering firstly a “network-centric” embodiment, that is an embodiment that is implemented substantially autonomously within the network, FIG. 1 illustrates a network architecture comprising a (generic) wireless access network 1 that is configured to determine a playout latency and quality value by examining data packets [without notification/input from either the client terminal or the media server]. The wireless access network could be, for example, a 3G or Long Term Evolution (LTE) network. The client terminal in this case is a mobile terminal 2 on which is installed a media client 3, e.g. BBC iPlayer™. The wireless access network 1 is coupled via a packet transmission mechanism 4 and the Internet 5 to a multiplicity of media servers 6, one of which is illustrated in FIG. 1. The network 1 further comprises a “tap” module 7 configured to divert a copy of the PD streams in transit to a DPI module 8. The original stream is forwarded to a Radio Resource Management (RRM) entity 12 which is discussed further below.

In order to determine packet priority within a PD stream, the Deep Packet Inspection (DPI) module 8 is configured to look into and examine packet headers and, in some cases, packet payload data. The DPI module comprises a PD session separator 9 which identifies PD sessions (as distinct from other session) and determines which packets belong to which PD session. For each PD session, the wireless access network provides a Session Analysis Module 10, implemented as a software process or module. The DPI module 8 forwards packets to the appropriate Session Analysis Module 10, which determines the Playout Latency and Quality Value for each packet.

A Session Analysis Module 10 needs to know, for the PD session that it is handling, when and at what position (in the media file) the playout started or re-started. At playback events (pausing, resuming, jumping in the video, fast forward, etc) the Session Analysis Module 10 needs to update its knowledge about which part of the media file is currently playing. It can do this by starting a “playout” timer when the first packet in a media file is sent onwards to the client, and adjusting that timer when a first packet in a rebuffering operation is sent. The Session Analysis Module can detect a rebuffering process by observing when the playout time of a packet received from the media server lags behind the current time held by the playout timer. This packet is taken as the first packet in the rebuffering process, and the playout time is reset to the specified playout time of the packet (this value is contained within the packet header).

For a given packet in a PD session, the Session Analysis Module 10 determines the time difference between the playout time specified in the packet header and the current time held in the playout timer. Using this difference it computes a Playout Latency factor. The Session Analysis Module 10 also allocates a Quality factor to each packet according to how important the packet payload is to the played-out media quality. For example, if the payload is or forms part of a base layer encoding, the packet may be allocated a high priority, whilst if it relates to an enhancement layer, the packet may be allocated a low priority. Each Session Analysis Module 10 forwards packets together with respective Playout Latency and Quality factors to a Prioritisation Module 11. Of course, rather than updating the Playout Latency and Quality factors for each packet in a PD stream, these factors may be allocated to the stream itself, such that dynamically varying Playout Latency and Quality factors are provided to the Prioritisation Module for each stream.

As well as receiving the Playout Latency and Quality factors from the Session Analysis Modules 10, the Prioritisation Module 11 also receives Session Priorities (e.g., operator policies, gold/silver user subscription levels, QCI, etc). Using all of the received information, the Prioritization Module 11 then determines and updates priorities for the ongoing progressive download sessions. An algorithm that might be deployed in the Prioritization Module 11 classifies a packet as “high priority” if it belongs to the base layer and its Playout Latency is less than a pre-determined threshold. All other packets are classified as “low priority”. A more sophisticated algorithm might combine Session Priority, Playout Latency and Quality Value, using a set of weights that are controlled by the operator. The output of this algorithm could be finer grained than just high/low priority.

An even more sophisticated algorithm could police resource use by individual users: scheduling solely on importance, for example, could prioritize very high resolution videos, since even the base layer of such videos would require higher a bandwidth than perhaps all the layers of a lower resolution video. Applying and policing, within the Prioritization Module, individual bandwidth caps for users could help to mitigate this problem.

In the case where the Prioritisation Module is collocated with a Radio Resource Management (RRM) entity 12 within the wireless access network 1, e.g. an RNC in a 3G network or an eNB within a LTE network, or otherwise has a control interface to such an RRM entity, the priority associated with a packet or PD stream may be passed to the RRM entity outside of the stream itself. The radio scheduler within the RRM entity schedules packets for delivery over the radio interface taking into account the associated priority. In an alternative embodiment, the Prioritisation Module 11 may be integrated into or interfaced to a “pre-scheduler” which sits upstream of the RRM entity, with the pre-scheduler reordering packets, taking into account their priorities, before delivering them to the RRM entity.

In a further alternative embodiment, the Prioritisation Module may include the allocated priority as a marker within PD stream packets. For example, this could be achieved using the Differential Services (DiffServ) Code Point (DSCP) field within the IP packet header. In this case, the RRM entity or the pre-scheduler must have a mechanism for identifying and properly handling the DCCP values.

This network-centric approach embodiment has the advantage that it allows various pre-fetching strategies while still correctly identifying the importance of each packet. For example, the media player at the client terminal can employ a pre-fetching strategy of downloading basic codec layers ten minutes in advance (or for the entire video duration) while enhancement layers are only downloaded a short time into the future. The Prioritisation Module will correctly handle the downloaded packets. A further advantage of the approach is that it does not rely on client generated reports (e.g. the playout status at the client) and also works with non-cooperating or potentially malicious clients (e.g. a client is not able to fool the Prioritisation Module into allocating all packets within a session a high priority). A disadvantage of the network-centric approach might be that the codec employed by the server must be known to the DPI function, and that packets must carry unencrypted and un-obfuscated timing and layer information. In addition, the DPI function consumes extra network resources.

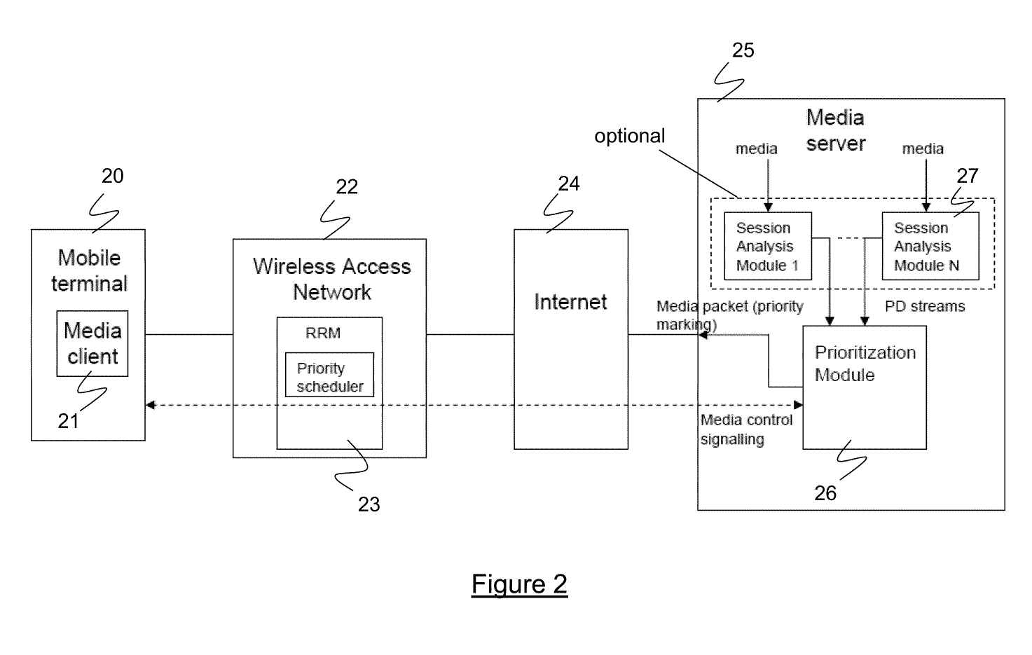

An alternative to the network-centric approach provides for explicit input from the media client or server (or cache) to the Prioritization Module regarding packet Playout Latency or Quality Value. In this case parts or all of the Session Analysis Module are replaced by this input. There is no requirement for a DPI process. This approach is referred to here as the “client or server assisted” approach and a possible network architecture is illustrated in general terms in FIG. 2. Present within the architecture are a mobile terminal 20 with installed media client 21, a wireless access network 22 with RRM entity 23, the Internet 24, and a media server 25 comprising a Prioritization Module 26 and Session Analysis Modules 27. NB. The Session Analysis Modules 27 are marked in the Figure as optional depending upon how much of the SAM functionality is replaced by the explicit input referred to above.

According to the client or server assisted approach, the mobile terminal 20 (or media server 25) may report the size of the current client playout buffer content to the Prioritization Module 26 within the media server 25. This would let the Prioritization Module 26 know how far the content of newly arriving packets is ahead of the current playout point, and hence determine the Playout Latency factor. In the case where the encoding layer is used to prioritise packets, the coding layer may be identified by the media server. The server could rate the quality value of each packet (e.g. according to coding layer) and place a marker in the IP packet header (e.g., classify the packet into one of the AF DiffSery classes). Using the marker, the Prioritization Module 26 can determine the Quality factor. A session priority may be determined by the Prioritization Module using, for example, bearer information such as the Quality of Service Class Identifier (QCI).

In the client or server assisted approach, the Prioritization Module and the Session Analysis Modules may alternatively be implemented within the wireless access network assuming that a suitable interface exists between the client terminal and the Prioritization Module (or between the media server and the Prioritisation Module). Of course, where the Prioritization Module does not have an interface with the RRM entity in the wireless access network, packets within a PD session must include the allocated priority (e.g. as a DSCP value).

Both the network-centric and client or server assisted approaches can be deployed to reduce waiting time at initial buffering and at rebuffering due to scrolling or temporary connectivity problems. This in turn may reduce the total number of rebuffering events for a given media download.

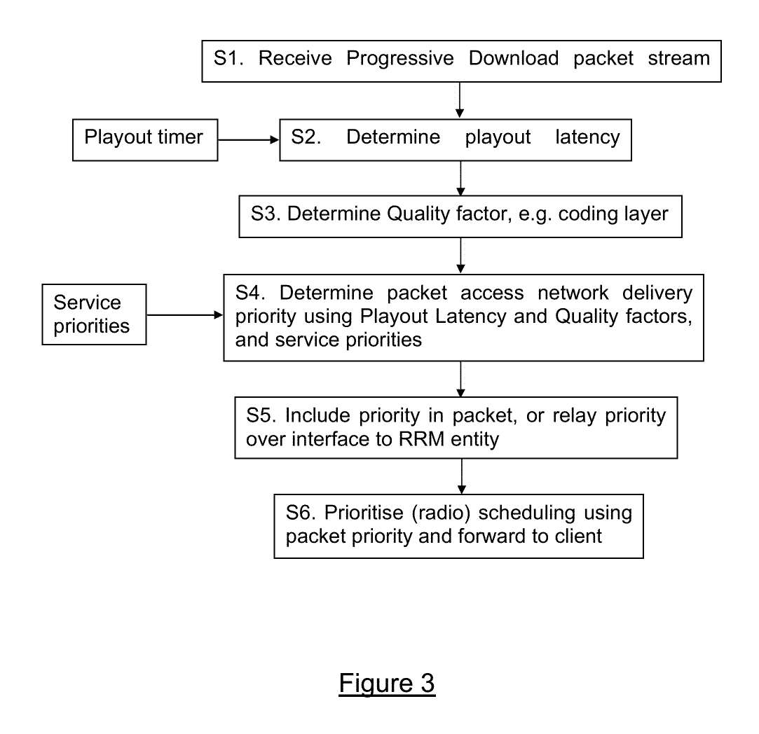

FIG. 3 is a flow diagram illustrating a generic process for efficiently handling the delivery of a PD stream generated at a media server. At step S1, the PD stream is received by some handling entity, e.g. within the media server of within the wireless access network. At step S2, the (current) playout latency of the stream, or of individual packets within the stream, is determined using the current value of the playout timer. The quality factor is determined at step S3, e.g. using the results of the DPI (coding layer etc). Than, at step S4, the packet or current stream priority is determined using the playout latency and quality factors, as well as any service priority (e.g. customer subscription level). The priority is included in each packet at step S5, or the priority delivered to the RRM entity (or possibly a pre-scheduling entity) over an appropriate interface. Finally, at step S6, packets are scheduled for delivery based upon the allocated (or current PD stream) priority.

It will be appreciated by the person of skill in the art that various modifications may be made to the above described embodiments without departing from the scope of the present invention.

1-15. (canceled)

16. A method of handling packets within a progressive download stream being delivered from a media server to a client terminal over an access network, the method comprising, for each packet:
determining one or both of (i) a playout latency factor indicative of the time duration until the media within the packet is required to be played out at the client terminal and (ii) a quality factor indicative of the importance of the media within the packet to the quality of the media to be played out at the client terminal; and
using the playout latency factor, or the quality factor, or both, to determine an access network delivery priority for the packet or to be applied to the progressive download stream.

17. The method of claim 16, further comprising using the determined access network delivery priority within the access network to prioritize the delivery of packets within the progressive download stream to the client terminal.

18. The method of claim 17, wherein said access network is a wireless access network, and wherein said step of using the determined access network delivery priority to prioritize the delivery of packets is carried out at a Radio Resource Management entity.

19. The method of claim 16, further comprising defining a service priority for the progressive download stream and using the service priority to determine said access network delivery priority.

20. The method of claim 16, further comprising performing, within the access network, a deep packet inspection of a packet to determine said playout latency or quality factor or both.

21. The method of claim 20, further comprising:
starting a media playout timer at the time of sending a first packet of the progressive download stream to the client terminal and adjusting that timer at the start of any rebuffering event;
determining, from said deep packet inspection, a playout time within the progressive download stream for the media within the packet; and
determining said playout latency factor using the difference between said playout time and the current value of the media playout timer.

22. The method of claim 16, further comprising inserting the determined access network delivery priority into the packet and forwarding the packet towards the client terminal.

23. The method of claim 22, wherein said priority is inserted into a Differential Services Code Point field of the packet.

24. The method of claim 16, further comprising providing the allocated access network delivery priority to a Radio Resource Management entity within the access network via a control interface.

25. An apparatus for handling packets within a progressive download stream for delivery from a media server to a client terminal over an access network, the apparatus comprising:
a session analysis circuit for determining, for each packet of the progressive download stream, one or both of (i) a playout latency factor indicative of the time duration until the media within the packet is required to be played out at the client terminal and (ii) a quality factor indicative of the importance of the media within the packet to the quality of the media to be played out at the client terminal; and
a prioritization circuit for determining an access network delivery priority for the packet, or to be applied to the progressive download stream, using the playout latency factor or the quality factor, or both.

26. The apparatus of claim 25, wherein said session analysis circuit performs a deep packet inspection of packets in order to determine said playout latency and quality factors.

27. The apparatus of claim 25, said prioritization module being configured to include said delivery priority within each packet.

28. The apparatus of claim 25, further comprising an interface for coupling the prioritization module to a Radio Resource Management entity, the prioritization module being configured to send the access network delivery priorities over that interface.

29. A network node comprising the apparatus of claim 28 and a Radio Resource Management entity.

30. A media server comprising the apparatus of claim 27.
